(19) United States
(12) Patent Application Publication
(10) Pub. No.: US 2025/0076484 A1
(43) Pub. Date: Mar. 6, 2025

(54) NEGOTIATING CARRIER-PHASE MEASUREMENT INTERVAL IN FTM PROTOCOL

(71) Applicant: Samsung Electronics Co., Ltd., Suwon-si (KR)

(72) Inventors: Vishnu Vardhan Ratnam, Plano, TX (US); Wei Sun, Allen, TX (US); Bilal Sadiq, Plano, TX (US); Hao Chen, Allen, TX (US); Shunyao Wu, Allen, TX (US); Boon Loong Ng, Plano, TX (US); Jianzhong Zhang, Dallas, TX (US)

(21) Appl. No.: 18/808,995

(22) Filed: Aug. 19, 2024

Related U.S. Application Data
(60) Provisional application No. 63/536,860, filed on Sep. 6, 2023.

(51) Int. Cl. G01S 13/74

(52) U.S. Cl. CPC G01S 13/74

(57) ABSTRACT

Methods and apparatuses for negotiating a carrier-phase measurement interval in FTM protocol. A method of wireless communication performed by a first STA, the method comprising: negotiating, with a second STA, a duration of a time window for performing carrier-phase (CP) ranging; negotiating, with the second STA, a desired maximum speed of the first STA to be tracked; and negotiating, with the second STA, one or more inter-packet time parameters for use within the time window based on the desired maximum speed of the first STA to be tracked.

### CROSS-REFERENCE TO RELATED APPLICATION(S) AND CLAIM OF PRIORITY

This application claims priority under 35 U.S.C. § 119(e) to U.S. Provisional Patent Application No. 63/536,860 filed on Sep. 6, 2023, which is hereby incorporated by reference in its entirety.

### TECHNICAL FIELD

This disclosure relates generally to ranging in wireless communications systems, and more particularly to negotiating a carrier-phase measurement interval in Fine Timing Measurement (FTM) protocol.

### BACKGROUND

Wireless local area network (WLAN) technology allows devices to access the internet in the 2.4 GHz, 5 GHz, 6 GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

Indoor positioning has grown in popularity over the last decade in parallel with the growth in the number of personal wireless devices as well as wireless infrastructure. While the use cases are plentiful and include smart homes and buildings, surveillance, disaster management, industry and healthcare, they all require wide availability and good accuracy. A key step of most positioning/localization solutions is ranging which involves identification of the distance (or a difference in distances) of the target device from a set of anchor devices whose locations are known. Correspondingly there can be some ranging techniques in Ultra-wide band (UWB), Lidar and WiFi. WiFi standards groups like 802.11mc and 802.11az have been specifically tailored for enabling accurate WiFi-based ranging via the Fine Timing Measurement (FTM) protocol. Some FTM methods can include: enhanced distribution channel access (EDCA)-based ranging, Trigger-based (TB) ranging, non-TB ranging, and Passive TB ranging.

### SUMMARY

Embodiments of the present disclosure provide methods and apparatuses for negotiating a carrier-phase measurement interval in FTM protocol.

In one embodiment, a method of wireless communication performed by a first STA, the method comprising: negotiating, with a second STA, a duration of a time window for performing carrier-phase (CP) ranging; negotiating, with the second STA, a desired maximum speed of the first STA to be tracked; and negotiating, with the second STA, one or more inter-packet time parameters for use within the time window based on the desired maximum speed of the first STA to be tracked.

In another embodiment, a first STA comprises a transceiver, and a processor operably coupled to the transceiver. The processor is configured to: negotiate, with a second STA, a duration of a time window for performing CP ranging; negotiate, with the second STA, a desired maximum speed of the first STA to be tracked; and negotiate, with the second STA, one or more inter-packet time parameters for use within the time window based on the desired maximum speed of the first STA to be tracked.

In yet another embodiment, a responding station (RSTA) comprises a transceiver, and a processor operably coupled to the transceiver. The processor is configured to: receive a message from an initiating station (ISTA) requesting carrier-phase (CP) measurement; transmit, to the ISTA, an indication for support of the CP measurement; negotiate, with the ISTA, a duration of a time window for performing carrier-phase (CP) ranging; negotiate, with the ISTA, a desired maximum speed of the ISTA to be tracked; and negotiate, with the ISTA, one or more inter-packet time parameters for use within the time window based on the desired maximum speed of the ISTA to be tracked.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of the present disclosure;

FIG. 3 illustrates an example of the frame exchange during the measurement phase of EDCA ranging according to various embodiments of the present disclosure;

FIG. 4 illustrates an example of the frame exchange during the measurement phase of TB ranging according to various embodiments of the present disclosure;

FIG. 5 illustrates an example of the frame exchange during the measurement phase of non-TB ranging according to various embodiments of the present disclosure;

FIG. 6 illustrates an example of differential ranging according to various embodiments of the present disclosure;

FIG. 7 illustrates an example of carrier-phase (CP) ranging duration according to various embodiments of the present disclosure;

FIG. 8 illustrates an example of a CP-specific sub-element of the FTM parameters element or ranging parameters element according to various embodiments of the present disclosure;

FIG. 9 illustrates an example of a CP ranging interval according to various embodiments of the present disclosure;

FIG. 10 illustrates another example of a CP-specific sub-element of the FTM parameters element or ranging parameters element according to various embodiments of the present disclosure;

FIG. 11 illustrates an example of a CP measurement exchange with two levels of measurement intervals according to various embodiments of the present disclosure;

FIG. 12 illustrates another example of a CP-specific sub-element of the FTM parameters element or ranging parameters element according to various embodiments of the present disclosure;

FIG. 13A illustrates an example carrier frequency offset (CFO) repetition in each frame CP-ranging exchange sequence according to various embodiments of the present disclosure;

FIG. 13B illustrates an example CFO repetition only at the beginning of each CFO period according to various embodiments of the present disclosure;

FIG. 14 illustrates yet another example of a CP-specific sub-element of the FTM parameters element or ranging parameters element according to various embodiments of the present disclosure;

FIG. 15 illustrates still another example of a CP-specific sub-element of the FTM parameters element or ranging parameters element according to various embodiments of the present disclosure;

FIG. 16 illustrates an example of a CP Measurement exchange with both level 2 frame exchange and CFO frame exchange negotiated according to various embodiments of the present disclosure;

FIG. 17 illustrates an example flow diagram of a method for wireless communication performed by an initiating station (ISTA) to negotiate the required parameters for CP-based ranging according to embodiments of the present disclosure;

FIG. 18 illustrates an example flow diagram of a method for wireless communication performed by a responding station (RSTA) to negotiate the required parameters for CP-based ranging according to embodiments of the present disclosure; and

FIG. 19 illustrates an example flow diagram of a method for wireless communication performed by a first station (STA) to negotiate the required parameters for CP-based ranging according to embodiments of the present disclosure.

### DETAILED DESCRIPTION

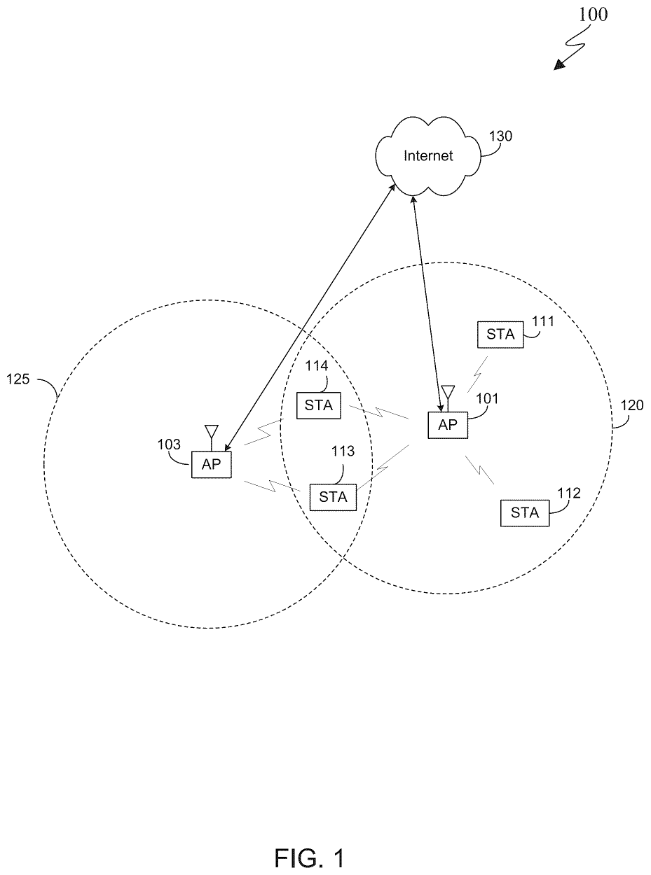

FIGS. 1 through 19, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE std. 802.11-2020, “Wireless LAN Medium Access Control (MAC) and Physical Layer (PHY) Specification”; [2] IEEE P802.11az/D5.0.

Embodiments of the present disclosure recognize that by using the carrier phase-information measured by an RSTA and ISTA, i.e., the angle of the complex channel estimate measured at the 0^{th}-subcarrier, an accurate differential range estimation can be performed whose precision is not limited by the system bandwidth, unlike the range estimate obtained from the conventional FTM protocol. However, carrier phase measurements typically need to be made at very frequent intervals of around 10 ms to track user speeds up to 1 m/s. This can cause a large overhead of frame exchanges. In addition, conventional mechanisms for estimation of the carrier frequency offset (CFO) may not provide the sufficient precision in the estimated CFO that is needed for the carrier phase-based ranging.

Accordingly, embodiments of the present disclosure can provide mechanisms to negotiate the intervals for carrier phase measurements between a first STA and a second STA (such as an ISTA and an RSTA) following the FTM protocol, to maximize the trackable user speed, and enable accurate carrier frequency offset correction, while keeping the frame exchange overhead low.

Embodiments of the present disclosure provide methods and apparatuses for an ISTA and an RSTA to negotiate a time window for performing CP ranging and inter-packet time parameters for use within the time window, wherein the inter-packet time parameters are determinable by desired maximum speed of ISTA to be tracked and wherein the time window is a subset of a FTM ranging session. In addition, embodiments of the present disclosure provide methods and apparatuses for an ISTA and an RSTA to negotiate a two-level pattern for inter-packet times of carrier phase measurements to maximize detectable ISTA speed, while balancing frame exchange overhead, where the two-level pattern includes a smaller inter-packet time type to track coarse speed up to a maximum detectable ISTA speed and a larger type to refine fine speed and balance overhead. Further, embodiments of the present disclosure provide methods and apparatuses for an ISTA and an RSTA to negotiate a periodic exchange of multiple Physical Protocol Data Units (PPDUs) in a transmit opportunity (TXOP) to enable accurate carrier CFO estimation, including a number of PPDUs exchanged within the TXOP, inter-PPDU time parameters, and/or an interval between successive CFO estimations.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques. The STAs 111-114 may communicate with each other using peer-to-peer protocols, such as Tunneled Direct Link Setup (TDLS).

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating negotiating a carrier-phase measurement interval in FTM protocol. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

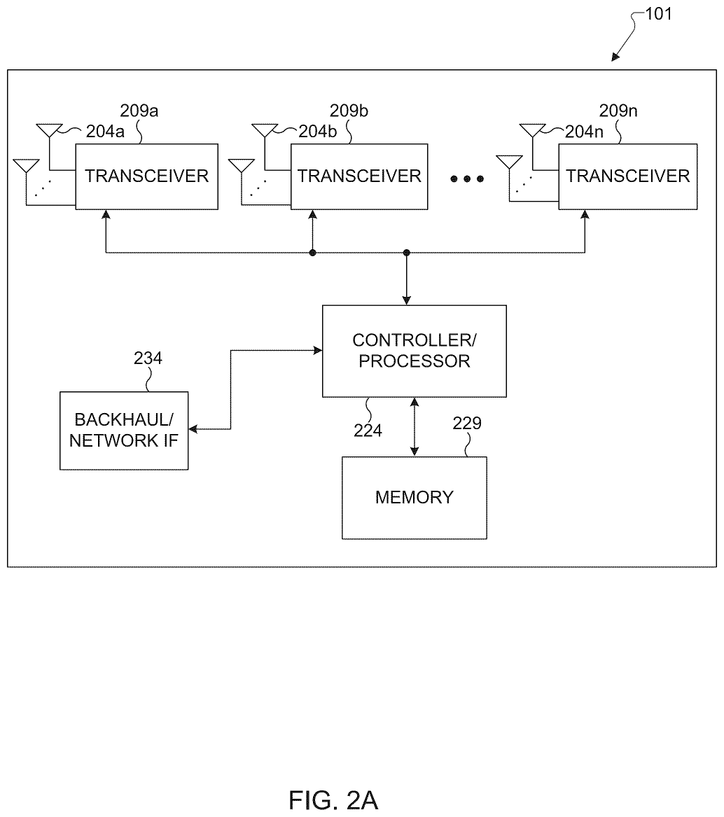

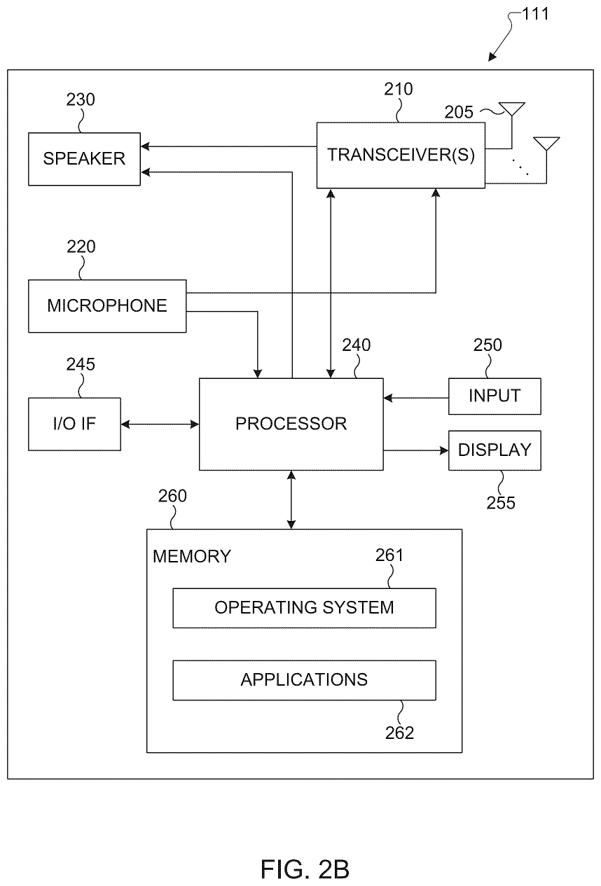

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

The AP 101 includes multiple antennas 204a-204n and multiple transceivers 209a-209n. The AP 101 also includes a controller/processor 224, a memory 229, and a backhaul or network interface 234. The transceivers 209a-209n receive, from the antennas 204a-204n, incoming radio frequency (RF) signals, such as signals transmitted by STAs 111-114 in the network 100. The transceivers 209a-209n down-convert the incoming RF signals to generate IF or baseband signals. The IF or baseband signals are processed by receive (RX) processing circuitry in the transceivers 209a-209n and/or controller/processor 224, which generates processed baseband signals by filtering, decoding, and/or digitizing the baseband or IF signals. The controller/processor 224 may further process the baseband signals.

Transmit (TX) processing circuitry in the transceivers 209a-209n and/or controller/processor 224 receives analog or digital data (such as voice data, web data, e-mail, or interactive video game data) from the controller/processor 224. The TX processing circuitry encodes, multiplexes, and/or digitizes the outgoing baseband data to generate processed baseband or IF signals. The transceivers 209a-209n up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the transceivers 209a-209n in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including facilitating negotiating a carrier-phase measurement interval in FTM protocol. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for facilitating negotiating a carrier-phase measurement interval in FTM protocol. Although FIG. 2A illustrates one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. Alternatively, only one antenna and transceiver path may be included, such as in other APs. Also, various components in FIG. 2A could be combined, further subdivided, or omitted and additional components could be added according to particular needs.

FIG. 2B illustrates an example STA 111 according to various embodiments of the present disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

The STA 111 includes antenna(s) 205, transceiver(s) 210, a microphone 220, a speaker 230, a processor 240, an input/output (I/O) interface (IF) 245, an input 250, a display 255, and a memory 260. The memory 260 includes an operating system (OS) 261 and one or more applications 262.

The transceiver(s) 210 receives from the antenna(s) 205, an incoming RF signal (e.g., transmitted by an AP 101 of the network 100). The transceiver(s) 210 down-converts the incoming RF signal to generate an intermediate frequency (IF) or baseband signal. The IF or baseband signal is processed by RX processing circuitry in the transceiver(s) 210 and/or processor 240, which generates a processed baseband signal by filtering, decoding, and/or digitizing the baseband or IF signal. The RX processing circuitry sends the processed baseband signal to the speaker 230 (such as for voice data) or is processed by the processor 240 (such as for web browsing data).

TX processing circuitry in the transceiver(s) 210 and/or processor 240 receives analog or digital voice data from the microphone 220 or other outgoing baseband data (such as web data, e-mail, or interactive video game data) from the processor 240. The TX processing circuitry encodes, multiplexes, and/or digitizes the outgoing baseband data to generate a processed baseband or IF signal. The transceiver(s) 210 up-converts the baseband or IF signal to an RF signal that is transmitted via the antenna(s) 205.

The processor 240 can include one or more processors and execute the basic OS program 261 stored in the memory 260 in order to control the overall operation of the STA 111. In one such operation, the processor 240 controls the reception of forward channel signals and the transmission of reverse channel signals by the transceiver(s) 210 in accordance with well-known principles. The processor 240 can also include processing circuitry configured to facilitate negotiating a carrier-phase measurement interval in FTM protocol. In some embodiments, the processor 240 includes at least one microprocessor or microcontroller.

The processor 240 is also capable of executing other processes and programs resident in the memory 260, such as operations for facilitating negotiating a carrier-phase measurement interval in FTM protocol. The processor 240 can move data into or out of the memory 260 as required by an executing process. In some embodiments, the processor 240 is configured to execute a plurality of applications 262, such as applications for facilitating negotiating a carrier-phase measurement interval in FTM protocol. The processor 240 can operate the plurality of applications 262 based on the OS program 261 or in response to a signal received from an AP. The processor 240 is also coupled to the I/O interface 245, which provides STA 111 with the ability to connect to other devices such as laptop computers and handheld computers. The I/O interface 245 is the communication path between these accessories and the processor 240.

The processor 240 is also coupled to the input 250, which includes for example, a touchscreen, keypad, etc., and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

Fine Timing Measurement (FTM) is a wireless network management procedure that allows a STA to determine its range, relative range and its direction to or from another STA using Time Of Flight (TOF), time difference of arrival and phase measurement. For a STA to obtain its location, the STA may perform this procedure with multiple STAs whose locations are known. The protocol was first proposed in IEEE 802.11-2016 (also called 802.11mc) and has since been updated in the newly drafted IEEE 802.11az standard.

An FTM session is an instance of an FTM procedure between an initiating station (ISTA) and a responding station (RSTA) that have an associated set of parameters. The capability of performing FTM initiation and response are indicated in FTM Responder field and FTM Initiator field of the Extended Capabilities element. It includes 3 phases: Negotiation->measurement exchange->termination. An ISTA can have multiple concurrent FTM sessions with different RSTAs.

### Negotiation Phase

In some embodiments, in the negotiation phase, the ISTA negotiates with the RSTA the key parameters, such as frame format and bandwidth, number of bursts, burst duration, the burst period, and the number of measurements per burst, etc., to use for the ranging. For this parameter negotiation, the ISTA transmits an initial FTM request (IFTMR) frame, wherein the parameters are included in the FTM parameters element (in case of EDCA ranging) or in Ranging Parameters element (in case of TB/non-TB/Passive TB ranging). The RSTA responds with an initial FTM (IFTM) frame within a time period (e.g., 10 ms) including either the FTM Parameters element (in case of EDCA ranging) or Ranging Parameters element (in case of TB/non-TB/Passive TB ranging). These parameters may be same as what were requested by the ISTA, or they may be over-ridden by RSTA for implementation dependent reasons. After the negotiation is completed successfully, an FTM session is established. In case of TB or non-TB ranging, a secure FTM session is established when an ISTA and an RSTA establish a pairwise transient key security association (PTKSA) and use it to exchange a Protected FTM Request Action frame (as the IFTMR frame), and the corresponding Protected FTM Action frame (as the IFTM frame).

### Negotiation for EDCA Ranging

In some embodiments, the IFTMR frame has the Trigger field set to 1 and has a set of scheduling parameters that describe the ISTA's availability for measurement exchange in a FTM Parameters field of the IFTMR frame. These parameters can include Number of Bursts Exponent, Burst Duration, Min Delta FTM, Partial TSF Timer, FTMs per Burst, burst Period, etc. If the request is successful, the RSTA can indicate, in the Format And Bandwidth subfield of the FTM Parameters field of IFTM frame, a format and bandwidth that can be used. The indication can comply with what the ISTA supports. When the RSTA cannot support the ISTA's Min Delta FTM or Number of Bursts Exponent constraints or cannot fulfill the request by the ISTA, the RSTA sets the Status Indication field accordingly in the IFTM frame and the FTM session ends.

### Negotiation of TB and Non-TB Ranging

In some embodiments, for TB and non-TB ranging measurement exchange, the IFTMR and IFTM frames include a Ranging Parameters element containing the non-TB specific sub-element or the TB specific sub-element. If the ISTA does not intend to share measurement results with the RSTA, the ISTA sets the initiator-to-responder (I2R) link management report (LMR) Feedback subfield in the Ranging Parameters field, in the IFTMR frame, to 0. When the I2R LMR Feedback subfield in the IFTMR frame is equal to 1, then the RSTA sets the I2R LMR Feedback subfield to 1 to indicate it requests the ISTA to transmit the I2R LMR or to 0 otherwise. The ISTA includes one ISTA Availability Window element in the TB specific sub-element in the IFTMR frame indicating its availability for TB ranging as well as the requested periodicity. The periodicity can be expressed, for example, in units of 10 TUs and can be a multiple of the Beacon Interval of the RSTA. The RSTA includes a TB-specific sub-element in an IFTM frame and includes an RSTA Availability Window element in the IFTM frame. The Availability Window Information field represents the availability window assigned by the RSTA to the ISTA.

### Passive TB Ranging

In some embodiments, the negotiation mechanism for passive TB ranging can be similar to TB ranging with a few differences. Firstly, an ISTA intending to set up a passive TB ranging session with an RSTA may set the Passive TB Ranging field in the TB specific sub-element of an IFTMR frame it transmits to the RSTA to 1. To assign an ISTA a passive TB ranging session, the RSTA can respond with the Passive TB Ranging subfield in the Ranging Parameters field set to 1 in the corresponding IFTM frame. In addition, each of the access points operating as an RSTA announces the timing and bandwidth of its ranging availability window for passive TB ranging in its beacon in an RSTA Availability Window element. This is so that a passive STA (PSTA) can be aware of the time when the FTM frames can be passively observed.

### Passive Ranging

In some embodiments, a third STA or passive STA (PSTA) may passively monitor the frame exchanges between the ISTA and the RSTA to track itself. The PSTA may first indicate to either the ISTA or the RSTA that it wants to perform CP ranging by indicating parameters such as the maximum speed, duration of ranging, average interval, etc. Then the negotiation may begin between the ISTA and RSTA as described herein.

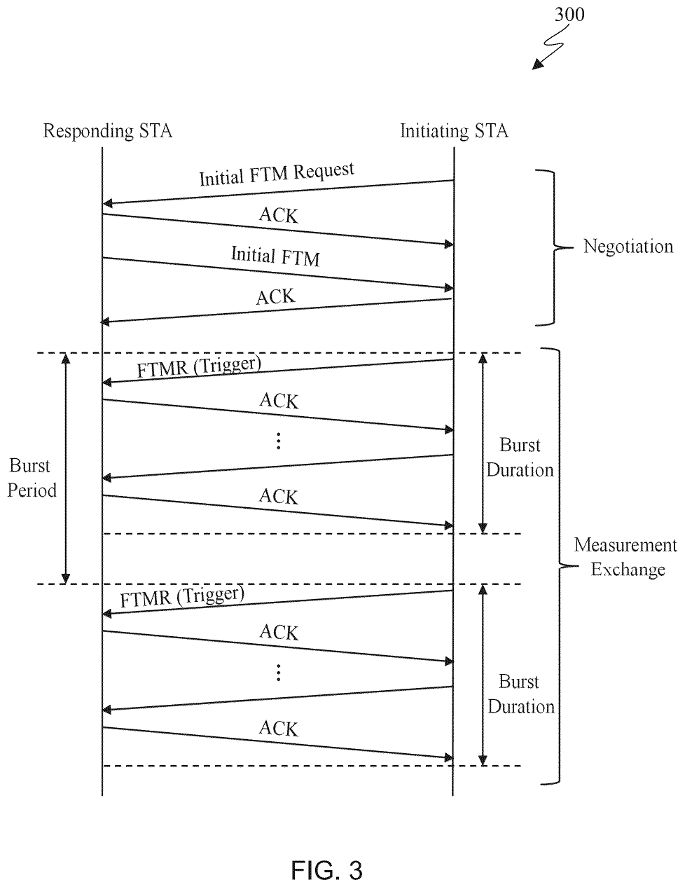

FIG. 3 illustrates an example of the frame exchange during the measurement phase of enhanced distribution channel access (EDCA) ranging 300 according to various embodiments of the present disclosure. The embodiment of the example of the frame exchange during the measurement phase of enhanced distribution channel access (EDCA) ranging 300 shown in FIG. 3 is for illustration only. Other embodiments of the example of the frame exchange during the measurement phase of enhanced distribution channel access (EDCA) ranging 300 could be used without departing from the scope of this disclosure.

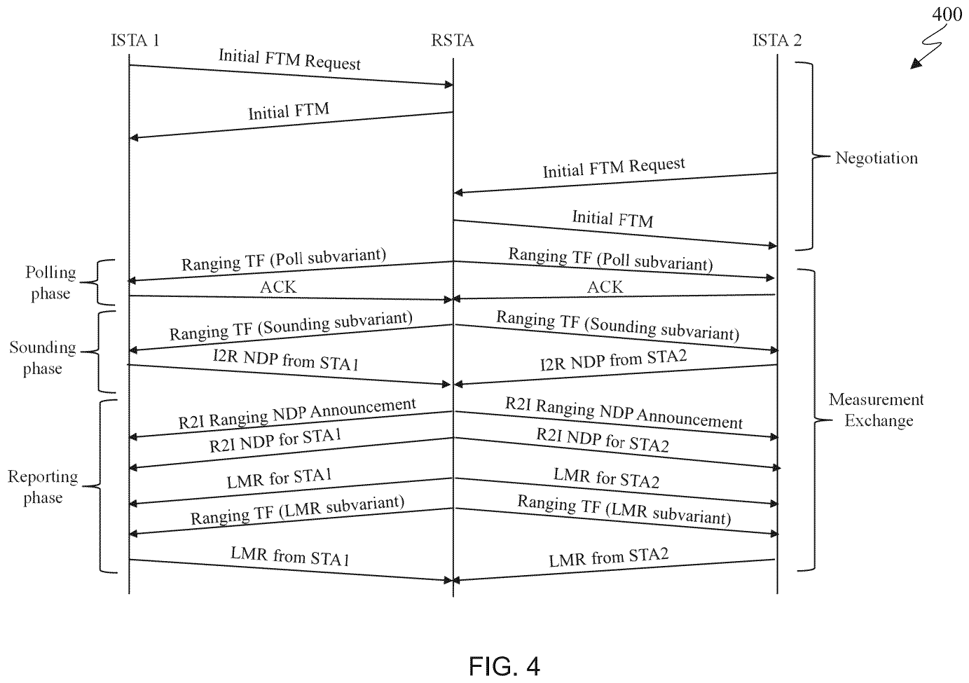

FIG. 4 illustrates an example of the frame exchange during the measurement phase of trigger-based (TB) ranging 400 according to various embodiments of the present disclosure. The embodiment of the example of the frame exchange during the measurement phase of trigger-based (TB) ranging 400 shown in FIG. 4 is for illustration only. Other embodiments of the example of the frame exchange during the measurement phase of trigger-based (TB) ranging 400 could be used without departing from the scope of this disclosure.

### Measurement Phase

In some embodiments, the frequency of the clock used for FTM timestamps is derived from same reference oscillator as the transmit center frequency. The measurement phase can include a periodic sequence of bursts, and each burst can include one or more (Fine Time) measurements. The duration of a burst and the number of measurements therein are defined by the parameters burst duration and FTMs per burst. The bursts are separated by an interval defined by the parameter burst duration.

### Measurement Exchange in EDCA Ranging

In some embodiments, a measurement exchange phase includes a periodic sequence of bursts. The timing of burst instances is determined by Partial TSF timer, Burst duration and Burst period in the FTM Parameters element of IFTM (sent during negotiation). The first burst instance can start at the value indicated by the partial TSF timer subfield of IFTM frame sent by RSTA. The TSF Synchronization Information field in FTM/IFTM frame can be used by the ISTA to synchronize its TSF with the RSTA's in order to determine the start time of subsequent bursts. The ISTA can request the RSTA to start the burst instances as soon as possible (ASAP) by setting ASAP subfield of the FTM Parameters element to 1.

In some embodiments, at the beginning of each burst instance, the ISTA indicates its availability by transmitting an FTMR frame without a FTM parameters element, but with the FTM Synchronization Information element present and with Trigger field set to 1. In response, the RSTA transmits an ACK (acknowledge) frame and can transmit “FTMs Per Burst” number of FTM frames before end of the burst instance. Subsequent FTM frames in a burst may not include the Synchronization Information element or FTM Parameters elements and are spaced apart by at least Min Delta FTM. These frame exchanges are illustrated in FIG. 3.

In some embodiments, both the FTM frame and the corresponding ACK are transmitted using a single transmit chain. Each FTM frame and its ACK within a session create one set of measured values. The RSTA captures the time at which the FTM frame is transmitted (t1) and ACK arrives (t4). The ISTA captures the time at which the FTM frame arrives (t2) and the time at which the ACK response is transmitted (t3). In the next FTM frame, in the same or the subsequent burst, the RSTA includes values of t1 and t4 in the TOD and TOA fields, respectively. These timestamp values (t1 and t4) are measured according to the RSTA's clock (without applying any frequency offset correction to the time bases). Using these 4 values the ISTA can estimate the round-trip time (RTT) as:

$$R T T = ( t {4}^{′} - t {1}^{′} ) - ( t 3 - t 2 ) ,$$

where t4′, t1′ are inferred from t4, t1 at the ISTA using an implementation dependent way. The FTM procedure can also be used to synchronize a local clock between STAs.

$$clock offset = [ ( t 2 - t {1}^{′} ) - ( t {4}^{′} - t 3 ) ] / 2$$

In some embodiments, the ISTA may track this clock offset over time to derive an estimate of the difference between the ISTA's time base and the RSTA's time base, thereby improving the accuracy of its derivation of t4′, t1′ from t4, t1. If an ACK is not received, the FTM frame is not retransmitted. Instead, the same info (except dialog token) is included in the next scheduled FTM frame, this is called the FTM retransmission procedure. When neither an ACK to an IFTM frame nor an FTMR frame are received by the RSTA, it does not terminate the FTM session before the time indicated by partial TSF+Burst Duration (i.e., end of first burst). During an FTM session, an ISTA can terminate the current session or request a new session with modified parameters by transmitting an FTMR frame with Trigger field set to 1 and including a new FTM parameters element. This FTMR frame can be the IFTMR frame for the new session.

### Measurement Exchange in TB Ranging

In some embodiments, it is a dynamic TB variant of FTM, that contains one or more scheduled periodic availability windows, and multiple ISTAs can participate simultaneously (to reduce overhead). The number of ISTAs participating can vary across the windows (hence dynamic). Each availability window can include one or more of a triplet of phases: Polling, Measurement Sounding, and/or Measurement Reporting. In some cases, within each availability window the RSTA and ISTAs do not transmit or trigger transmission of any Data frames; in some cases, they only perform ranging activities related to Polling, Measurement Sounding, and/or Measurement Reporting phases, as well as signaling of modification of availability window parameters. Each availability window by default comprises a single Transmission Opportunity (TXOP) and may be extended to multiple TXOPs by announcement, if a single TXOP is insufficient to accommodate all ISTAs that responded to the poll. Each availability window typically contains a single poll, where the RSTA polls all the ISTAs assigned to that availability window. If the available bandwidth is insufficient to accommodate all ISTAs in one poll, more extra polling/sounding/reporting triplets can be scheduled within the availability window. During the availability window, measurement resources and results are made available to each ISTA whose poll response was received at the RSTA. Inside Availability Windows allocated to itself, an ISTA does not transmit any frame except when assigned UL resources by a TF transmitted by the RSTA. The procedure within each of the phases are as shown below:
Polling phase of TB ranging: the RSTA transmits a Ranging Trigger frame (TF) of subvariant Poll but only one of them, and gets a response from ISTAs. Each RU in the Ranging TF is only allocated to one ISTA. Any ISTA addressed by a User Info field in a Ranging TF of subvariant Poll frame that intends to participate in the measurement sequence within this availability window sends a CTS-to-self in an S-MPDU within an HE TB PPDU in its designated RU allocation as identified in the TF Ranging Poll frame. Note: the S-MPDU is an A-MPDU with only one MPDU (MAC (media access control) Protocol Data Unit) with 1 in the EOF field. The More TF subfield of Common Info field of the TF is used to indicate if there are more TFs in the window.
Measurement sounding phase of TB ranging: It starts short inter-frame spacing (SIFS) after the end of polling phase. It includes one or more Ranging TFs of subvariant Sounding, allocating uplink (UL) resources to the ISTAs. Each Ranging TF of subvariant Sounding allocates UL spatial streams for one or more ISTAs' I2R NDP frames that are multiplexed in the spatial domain, each occupying the full bandwidth. A SIFS time after receiving the I2R NDPs from the ISTAs, the RSTA transmits an R2I Ranging NDP Announcement frame followed by an R2I NDP. The Ranging NDP Announcement frame's STA Info fields specify all the ISTAs that should use the R2I NDP, which include the ISTAs that were allocated UL spatial streams in the Ranging TF frame of subvariant sounding. The spatial streams and BW of the Ranging TF and Ranging NDP announcement comply with the capabilities of each of the indicated ISTAs. Both the RSTA and the ISTAs perform RTT measurements by capturing the timestamps of the NDPs. The ISTA can record the time the I2R NDP is transmitted (t1), and the RSTA the time it arrives (t2). Similarly, the RSTA captures the time R2I NDP is transmitted (t3) and the ISTA the time it arrives (t4). The RSTA uniquely identifies each Ranging NDP Announcement frame by the Sounding Dialog Token Number field. Thus, each measurement instance is associated with a Sounding Dialog Token Number field value. To aid in synchronizing the TSF time at the ISTAs, the RSTA includes in the Ranging NDP Announcement, a STA info field with AID11=2044, with the Partial TSF subfield set to partial TSF of RSTA at time of sending the Ranging TF of subvariant Poll.
Reporting phase of TB ranging: It begins SIFS after the measurement sounding phase. Results of the timing measurements are carried in LMR frames, which include the TOA, TOD, CFO Parameter fields etc. First, the RSTA transmits an R2I LMR to all ISTAs that were allocated resources in the preceding measurement sounding phase. All the R2I LMR frames can be carried in one HE MU PPDU, where each RU contains only one user, and the TOA carries value of t2 and TOD carries value of t3. Feedback type of LMR can be immediate (values correspond to current availability window) or delayed (values correspond to previous window). The Dialog Token subfield in LMR matches the Sounding Dialog Token in the Ranging NDP announcement frame for which TOA and TOD are reported. Using these values, the ISTA can estimate the round-trip time (RTT) as:

$$R T T = ( t 4 - t 1 ) - ( t {3}^{′} - t {2}^{′} ) ,$$

where t2′, t3′ are determined from t2, t3 in an implementation dependent way at the ISTA. If the I2R LMR was negotiated by one or more ISTAs, then a SIFS time after transmitting out the R2I LMR, the RSTA transmits a TF Ranging LMR to solicit the I2R LMR frame(s). This TF can allocate uplink resources to ISTAs that negotiated I2R LMR and were allocated resources in the preceding measurement sounding phase. The RSTA allocates each RU in the TF Ranging LMR to only one ISTA. In response to the TF Ranging LMR, each addressed ISTA responds by transmitting an I2R LMR frame, where the TOD carries the value of t1 and the TOD carries the value of t4. If I2R LMR reporting was negotiated, then the ISTA includes a CFO parameter in the I2R LMR as well. The ISTA estimates the CFO parameter based on the PPDU carrying the Ranging TF of subvariant Sounding that solicits the I2R NDP from the ISTA. The RSTA may account for clock rate differences between the ISTA and the RSTA based on the CFO parameter included in the received I2R LMR. The mechanism can be implementation specific. If a Secure FTM session is negotiated, the LMR is transmitted in Protected Fine Timing Action frames.

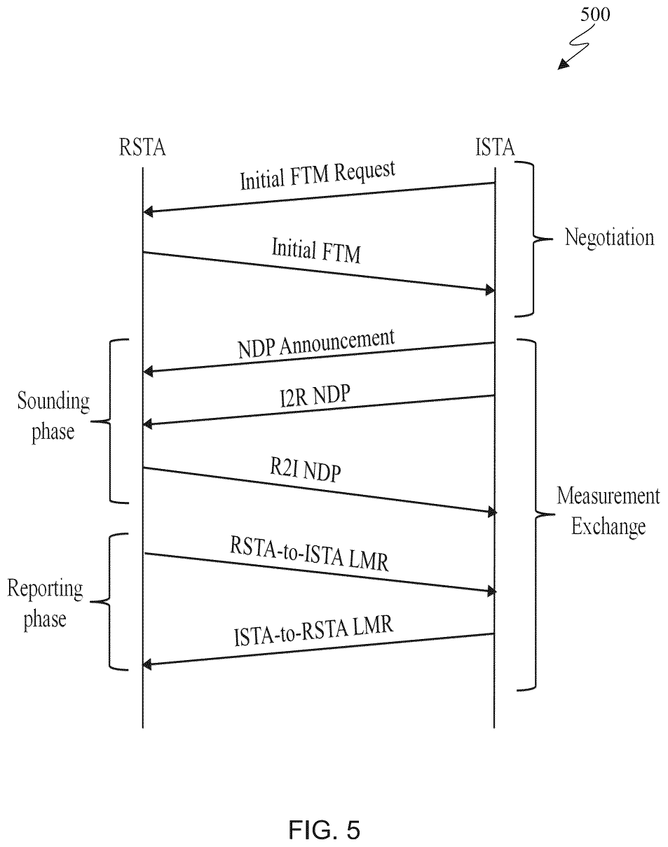

FIG. 5 illustrates an example of the frame exchange during the measurement phase of non-TB ranging 500 according to various embodiments of the present disclosure. The embodiment of the example of the frame exchange during the measurement phase of non-TB ranging 500 shown in FIG. 5 is for illustration only. Other embodiments of the example of the frame exchange during the measurement phase of non-TB ranging 500 could be used without departing from the scope of this disclosure.

Measurement Exchange in non-TB Ranging

In some embodiments, the protocol operates in an ISTA centric scheduling. The RSTA can only limit the frequency with which the ISTA can initiate measurements by setting a minimum time interval for the ranging exchange. It can include two phases: Measurement Sounding and Measurement Reporting.
Sounding phase of non-TB ranging: The ISTA initiates by transmitting a Ranging NDP Announcement frame to RSTA and a I2R NDP SIFS after. In response, the RSTA transmits an R2I NDP. The Min/Max Time Between Measurements are set in the fields of the IFTMR and IFTM frames (during negotiation). The ISTA maintains a Sounding Dialog Token counter modulo 64 for each FTM session. It is incremented before transmission of each Ranging NDP announcement frame to the RSTA, and its value is included in the NDPA. Both the RSTA and the ISTA perform RTT measurements by capturing the timestamps of the NDP. The ISTA can record the time the I2R NDP is transmitted (t1), and the RSTA the time it arrives (t2). Similarly, the RSTA captures the time R2I NDP is transmitted (t3) and ISTA the time it arrives (t4).
Reporting phase of non-TB ranging: The reporting phase can be similar to TB-ranging. It starts a SIFS after measurement phase and it can include LMR frame transmissions with immediate or delayed feedback, which include the TOA, TOD, CFO Parameter fields etc. First, the RSTA transmits an R2I LMR to the ISTA where the TOA carries a value of t2 and TOD carries a value of t3. The dialog token of the LMR frame is copied from the Sounding Dialog Token Number of the NDPA from the ISTA whose measurements are included in the LMR. Using these values, the ISTA can estimate the round-trip time (RTT) as:

$$R T T = ( t 4 - t 1 ) - ( t {3}^{′} - t {2}^{′} ) ,$$

where t2′, t3′ are determined from t2, t3 in an implementation dependent way at the ISTA. If I2R LMR feedback is negotiated, after a SIFS time of receiving the R2I LMR frame, the ISTA can transmit the I2R LMR frame to the RSTA. In the non-TB ranging, both the RSTA and the ISTA measure the CFO values independently based on reception of I2R NDP and R2I NDP respectively. They are not reported in LMRs (the CFO parameter fields are reserved in non-TB ranging). The RSTA and the ISTA may account for clock rate differences between the ISTA and the RSTA respectively based on their own measured CFO value.

### Termination Phase

### Termination in EDCA Ranging:

In some embodiments, an FTM session terminates after the last burst instance as indicated by number of bursts exponent, bursts duration, FTMs per Burst and Burst Period subfields in the FTM Parameters field of the IFTM frame. An FTM session may be terminated early by:
An RSTA sending an FTM frame with dialog token set to 0 during an active burst.
An ISTA transmitting an FTMR frame with trigger field set to 0.

### Termination in TB Ranging:

In some embodiments, a TB ranging FTM session may be terminated if the ISTA fails to respond to a Ranging TF of subvariant Poll and fails to receive one Ranging TF of subvariant Sounding (or Secure Sounding) within the Max Session Expiry interval. This interval is specified in the Max Session Exp field of the TB Ranging specific sub-element of the Ranging Parameters transmitted in the IFTM frame (during negotiation). A session can be terminated by the ISTA by sending an FTM Request frame with Trigger=0. A session can be terminated by the RSTA by transmitting an AMPDU with an R2I LMR frame and a FTM frame, with the Dialog Token field set to 0. The Follow up dialog token field is also set as 0.

### Termination Non-TB Ranging:

In some embodiments, a session can be terminated if the ISTA does not initiate a ranging instance within ‘Max Time Between Measurements’ of the last ranging instance. This value is reported in the Max Time Between Measurements subfield of the Ranging Parameters field of the IFTM frame transmitted in the negotiation phase. A session can be terminated by the ISTA by sending an FTM Request frame with Trigger=0. A session can be terminated by the RSTA by transmitting an AMPDU with an R2I LMR frame and a FTM frame, with the Dialog Token field set to 0. The Follow up dialog token field is also set as 0.

### Converting Measurements to Range and Location Estimates

In some embodiments, for positioning and proximity apps, the RTT (e.g., measured in seconds units) between the two STAs is translated into a distance or range as:

$$d = \frac{R T T}{2} \times 3 \times 1 {0}^{8} ( in meters ) .$$

In some embodiments, each FTM of the burst yields a distance sample, with multiple distance samples per burst. Given multiple FTM bursts and multiple measurements per burst, the distance samples can be combined in different ways to produce a representative distance measurement. For example, the mean distance can be reported, the median, or some other percentile. Furthermore, other statistics such as the standard deviation can be reported as well to be used by the positioning app.

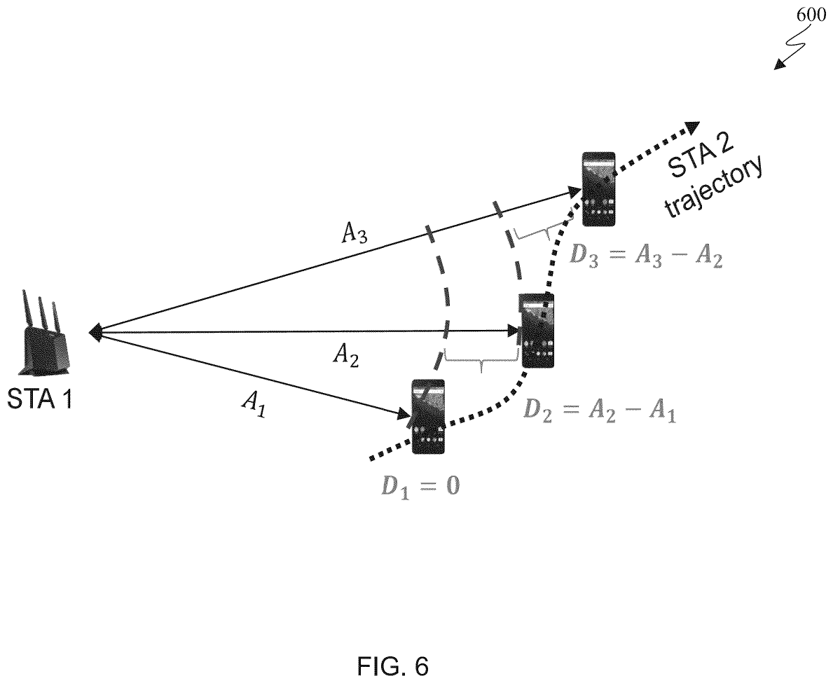

FIG. 6 illustrates an example of differential ranging 600 according to various embodiments of the present disclosure. The embodiment of the example of differential ranging 600 shown in FIG. 6 is for illustration only. Other embodiments of the example of differential ranging 600 could be used without departing from the scope of this disclosure.

### Differential Ranging

One drawback of FTM protocol-based ranging is its precision of 1 m, which is unsuitable for many applications. However, for many of these applications such as gesture recognition, pose estimation, velocity estimation, etc., knowing the absolute range may not be as important as tracking the differential range, i.e., the change in the range of a device over a time window of interest. If the true absolute range value of an ISTA with respect to an RSTA at the measurement time tₚ is equal to Aₚ, then the differential range at time tₚ can be defined as Dₚ≅Aₚ−Aₚ₋₁. This is depicted pictorially in FIG. 6.

By using the carrier phase measurements at an ISTA and an RSTA, which are the measurements of the angle of the complex channel estimate for the line-of-sight path measured at the 0^{th}-subcarrier (for packets transmitted by an RSTA and ISTA respectively), an accurate differential range estimation \hat{D}ₚ can be performed whose precision is not limited by the system bandwidth. This can offer a precision of <1 mm in differential range even with just 20 MHz bandwidth, a 100× improvement to FTM. The carrier phase measurements can be made as part of the FTM protocol and can be exchanged between the ISTA and the RSTA.

For ease of explanation of the present disclosure, the following model is considered. This model is only for illustration purposes and should not be considered as a limitation on the applicability of the present disclosure. A system where an ISTA intends to perform differential range estimates with respect to an RSTA is considered. For this the ISTA may use carrier-phase based ranging. In the carrier phase-based ranging, the ISTA and the RSTA may perform a sequence of frame exchanges over time. For the p-th frame exchange sequence, the ISTA first transmits a frame to the RSTA at time t_{p,1}. From the received frame the RSTA may estimate the carrier phase, after removing any symbol start time errors etc., as \hat{ψ}_{p,1}. After receiving the frame, the RSTA may transmit a frame to the ISTA which may be received at the ISTA at time t_{p,4}. From the received frame the ISTA may estimate the carrier phase, after removing any symbol start time errors etc., as \hat{ψ}_{p,2}. In addition, using the preambles and the pilot subcarriers present in the frames, the ISTA may also obtain estimates of the carrier frequency offset of the ISTA with respect to the RSTA as f̅_{CFO,p}. This carrier phase measurement \hat{ψ}_{p,1} may be shared by the RSTA with the ISTA to enable the differential ranging. The ISTA may perform further processing of the carrier phase measurements \hat{ψ}_{p,1}, \hat{ψ}_{p,2} that are collected over a time window to refine the estimate of the CFO to get \hat{f}_{CFO,p}. Then the ISTA may estimate the sum-carrier phase for the p-th frame exchange as:

$${\overline{Ψ}}_{p} {=}^{Δ} [ {\hat{ψ}}_{p , 1} + {\hat{ψ}}_{p , 2} - 2 π {\hat{f}}_{CFO , p} ( {t}_{p , 4} - {t}_{p , 1} ) ] .$$

The goal of the carrier phase-based ranging is to use the values of Ψ̅ₚ to estimate the differential range of the ISTA with respect to the RSTA. The differential range may further be integrated to obtain the relative range, i.e., the change in the range of the ISTA over a time period of interest.

### CP Ranging Duration

In some embodiments, the ISTA can initiate a Carrier-phase (CP) ranging (or fine ranging or high precision ranging) with an RSTA for a short time by transmitting to the RSTA an IFTMR frame with the Carrier Phase Measurement (CPM) Request field of the FTM Parameters element or the Ranging Parameters element set to 1. An ISTA that has an active existing FTM session with an RSTA may modify the negotiation to include a short window of CP ranging that includes CP reporting by transmitting an FTMR frame with the CPM Request field of the FTM Parameters element or the Ranging Parameters element set to 1. An RSTA may perform a similar modification to an FTM session, to include a short window of CP ranging, by setting the CPM Request field of the FTM Parameters element or the Ranging Parameters element in an FTM frame to 1.

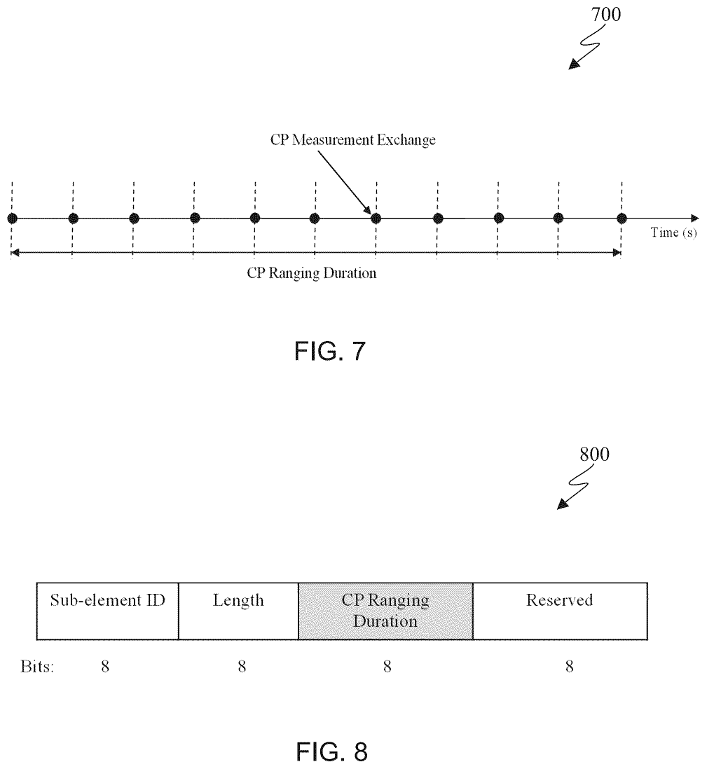

FIG. 7 illustrates an example of CP ranging duration 700 according to various embodiments of the present disclosure. The embodiment of the example of CP ranging duration 700 shown in FIG. 7 is for illustration only. Other embodiments of the example of CP ranging duration 700 could be used without departing from the scope of this disclosure.

As illustrated in FIG. 7, when the CPM Request field is present in the FTM Parameters element or the Ranging Parameters element, the ISTA may also include an indication of the duration of the CP ranging window that is requested. This duration is illustrated pictorially in FIG. 7.

FIG. 8 illustrates an example of a CP-specific sub-element of the FTM parameters element or ranging parameters element 800 according to various embodiments of the present disclosure. The embodiment of the example of a CP-specific sub-element of the FTM parameters element or ranging parameters element 800 shown in FIG. 8 is for illustration only. Other embodiments of the example of a CP-specific sub-element of the FTM parameters element or ranging parameters element 800 could be used without departing from the scope of this disclosure.

In one example, in case of EDCA ranging, the length of the window can be indicated by the Number Of Bursts Exponent and Burst Period fields in the FTM Parameters element. In another example, there can be a separate sub-element of the Ranging Parameters element or FTM Parameters element called a Carrier Phase (CP) Specific sub-element that includes a CP Ranging Duration field, to indicate the duration of the CP ranging window. The field can be, for example, in the units of 10 TUs, or TUs. The CP Specific sub-element can be included as a sub-element of the FTM Parameters element or the Ranging Parameters element when the CPM Request field is set to 1. An illustration of the CP-specific sub-element with this field is provided in FIG. 8. During this window the carrier phase information may be shared between the ISTA and the RSTA and the frequency of frame exchanges may be modified as described herein. In one embodiment, after the end of the indicated window, the CP ranging may end and the prior negotiated conventional FTM ranging parameters, if applicable, can be used without explicit signaling. In another embodiment, after the end of the indicated window the FTM session may be terminated, unless an explicit modification is performed before the expiry by sending an FTMR frame with the FTM Parameters element or the Ranging Parameters element included.

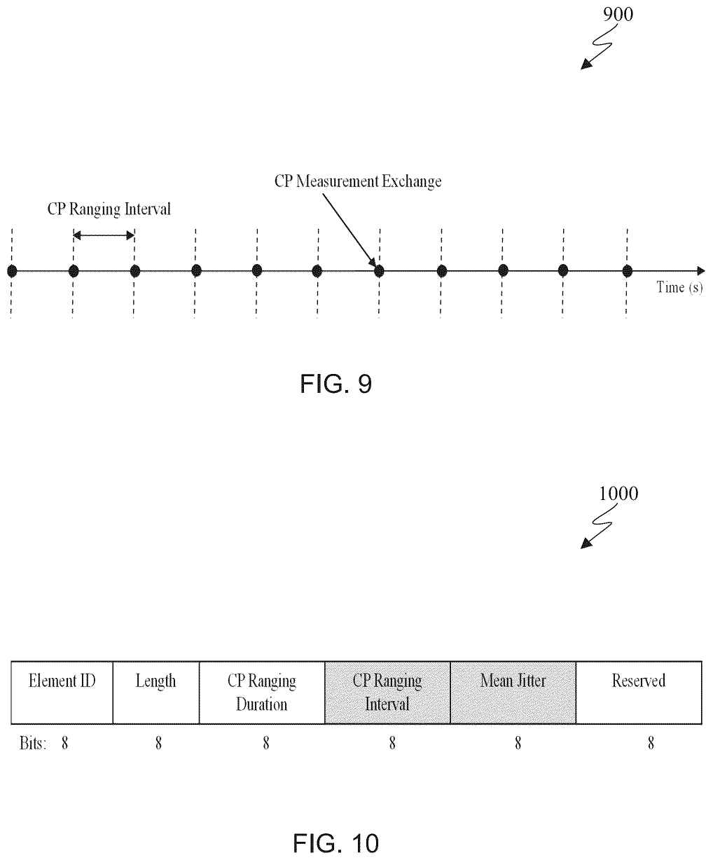

FIG. 9 illustrates an example of a CP ranging interval 900 according to various embodiments of the present disclosure. The embodiment of the example of a CP ranging interval 900 shown in FIG. 9 is for illustration only. Other embodiments of the example of a CP ranging interval 900 could be used without departing from the scope of this disclosure.

### One-Level CP Ranging Interval

In some embodiments, the ISTA may also negotiate the time interval between the successive CP measurements and the corresponding required frame exchanges. This interval is depicted pictorially in FIG. 9.

FIG. 10 illustrates another example of a CP-specific sub-element of the FTM parameters element or ranging parameters element 1000 according to various embodiments of the present disclosure. The embodiment of the example of a CP-specific sub-element of the FTM parameters element or ranging parameters element 1000 shown in FIG. 10 is for illustration only. Other embodiments of the example of a CP-specific sub-element of the FTM parameters element or ranging parameters element 1000 could be used without departing from the scope of this disclosure.

When the CPM Request field is present in the FTM Parameters element or the Ranging Parameters element of an FTMR frame, the ISTA may include an indication of the requested time interval between the CP measurements in that FTMR frame. In one example, in case of EDCA ranging, the time interval can be indicated by the Burst Duration and Min Delta FTM fields of the FTM Parameters element. In another example, in case of TB ranging, the time interval can be indicated via the Availability Window subfield of the TB-specific sub-element of the Ranging parameters element. In another example, in case of non-TB ranging, the time interval can be indicated via the Min Time Between Measurements and Max Time Between Measurements fields of the non-TB specific sub-element of the Ranging Parameters element. In yet another example, there can be a separate sub-element called Carrier Phase (CP) Specific sub-element that includes a CP Ranging Interval field, to indicate the time interval between adjacent CP measurements that are requested, as illustrated in FIG. 10. The field can be, for example, in the units of 10 TUs, or TUs. The CP Ranging Element can be included as a sub-element of the FTM Parameters element or the Ranging Parameters element when the CPM Request field is set to 1. In some embodiments, the interval may be selected to be the largest interval that allows unambiguous tracking of a desired maximum user tracking speed Sₘₐₓ. For example, the interval can be: T=3×10⁸/(4f_{c}Sₘₐₓ), where f_{c} is the carrier frequency. In one embodiment, instead of indicating the exact time interval, the indication can be of the maximum interval between successive CP measurements.

In some embodiments, the ISTA may also indicate a jitter parameter, that indicates the average time value by which each CP Ranging measurement time can be jittered to enable robust estimation of the differential range. The RSTA may correspondingly randomly jitter the transmission of each CP measurement frame based on the jitter parameter. This parameter can be included in the Mean Jitter subfield of the Carrier Phase Specific sub-element as depicted in FIG. 10.

In one example, using the sum-carrier phase measurements ψ̅ₚ made at times t_{p,1} (determined by the CP Ranging Interval), the differential range at time tₚ can be estimated as:

$${\hat{D}}_{p} = ( 3 \times 1 {0}^{8} ) \frac{mod \{ {\overline{Ψ}}_{p} - {\overline{Ψ}}_{p - 1} + π , 2 π \} - π}{4 π N {f}_{c}} .$$

In another example, a local user speed may be estimate as:

$${\hat{S}}_{p} = {arg max}_{\vert s \vert \leq {S}_{max}} \vert {\sum }_{q = p - a}^{p + a} {e}^{j ( {\overline{Ψ}}_{q} )} {e}^{- \frac{j 4 π {f}_{c} {t}_{q , 1} s}{3 \times {10}^{8}}} \vert ,$$

where a is a design parameter for averaging. With the local speed estimate Ŝₚ₋₁ at time tₚ₋₁, the differential range at time tₚ can be estimated as: \hat{D}ₚ=Ŝₚ(tₚ−tₚ₋₁).

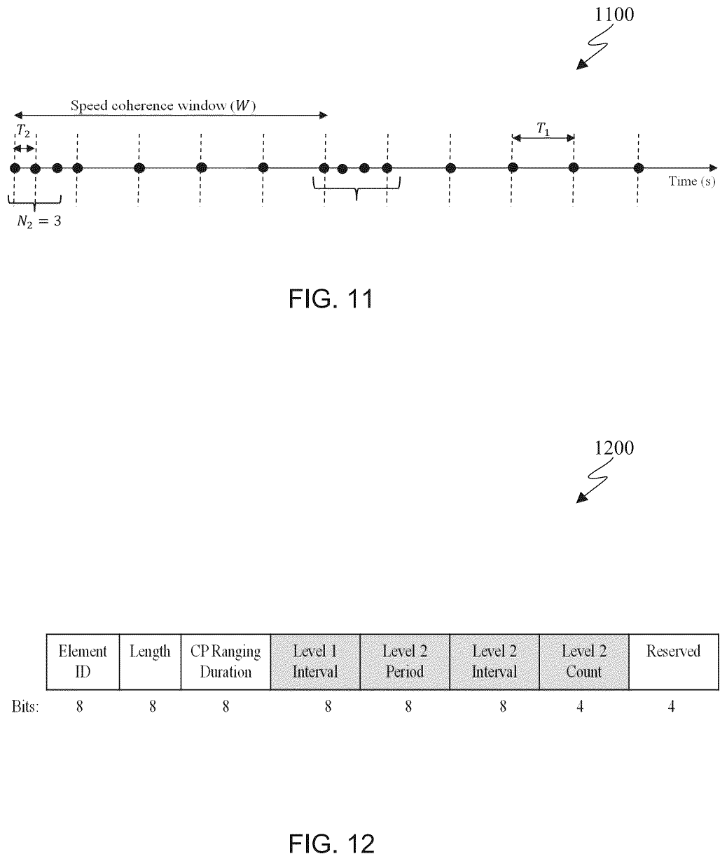

FIG. 11 illustrates an example of the CP measurement exchange with two levels of measurement intervals 1100 according to various embodiments of the present disclosure. The embodiment of the example of the CP measurement exchange with two levels of measurement intervals 1100 shown in FIG. 11 is for illustration only. Other embodiments of the example of the CP measurement exchange with two levels of measurement intervals 1100 could be used without departing from the scope of this disclosure.

### Two-Level CP Ranging Interval

In some embodiments, to keep the overhead low, it may be desirable to keep the average CP Ranging Interval to be large, e.g., 50 ms or 100 ms, but still allow unambiguous resolution of fast user speeds of, for example, 1 m/s. In such a case, a motion model may be assumed where the user speed remains constant for a speed coherence time of W seconds. Thus, in each window of W seconds, a few CP measurements may be performed at a finer time granularity of T₂=3×10⁸/(4f_{c}Sₘₐₓ) seconds, while the remaining CP measurements within the window of W seconds may have a larger spacing of, for example, T₁=50 ms or T₁=100 ms. The number of measurements performed at the finer time granularity T₂ may be N₂. This structure is depicted pictorially in FIG. 11.

FIG. 12 illustrates another example of a CP-specific sub-element of the FTM parameters element or ranging parameters element 1200 according to various embodiments of the present disclosure. The embodiment of the example of a CP-specific sub-element of the FTM parameters element or ranging parameters element 1200 shown in FIG. 12 is for illustration only. Other embodiments of the example of a CP-specific sub-element of the FTM parameters element or ranging parameters element 1200 could be used without departing from the scope of this disclosure.

The value of the speed coherence time W, the finer time interval T₂ the number of the finer time CP measurements N₂ and the coarser time interval T₁ may be negotiated by the ISTA with the RSTA in an FTMR frame. As an example, the above information can be carried in the CP Specific sub-element of the FTM Parameters element or the Ranging Parameters element. The speed coherence time W can be indicated in the Level 2 Period field of the sub-element that can be measured in units of TUs or 10 TUs. The finer time interval T₂ can be indicated in the Level 2 Interval field of the sub-element. The number of CP measurements N₂ with the fine time interval can be indicated in the Level 2 Count field of the sub-element. The coarser time interval of T₁ can be indicated in the Level 1 Interval field of the sub-element. The sub-element with these fields is depicted in FIG. 12.

The measurements with the Level 2 measurement interval spacing can be used to make a coarse estimation of the STA speed, while the measurements with the Level 1 interval spacing can be used to make a fine estimation of the STA speed. For example, in each window of W secs (indexed as w), using only the samples with T₂ inter-sample spacing (indexed as set Q_{w}), a coarse speed estimate for the window w can be obtained as:

$${\overline{S}}_{w} = {arg max}_{\vert s \vert \leq {S}_{max}} \vert {\sum }_{p ∈ {Q}_{w}} {e}^{j ( {\overline{Ψ}}_{p} )} {e}^{- \frac{j 4 π {f}_{c} {t}_{q , 1} s}{3 \times {10}^{8}}} \vert ,$$

where \hat{ψ}ₚ is the sum-carrier phase measurement for the frame exchange at time t_{p,1} and f_{c} is the carrier frequency. Then the fine speed estimate at the time of a frame exchange t_{p,1} can be obtained as:

$${\hat{S}}_{p} = {\overline{S}}_{w} + {arg max}_{\vert s \vert \leq {S}_{max}} \vert {\sum }_{q = p - a}^{p + a} {e}^{j ( {\overline{Ψ}}_{q} )} {e}^{-} \frac{j 4 π {f}_{c} {t}_{q , 1} ( s + {\overline{S}}_{w} )}{3 \times 1 {0}^{8}} \vert ,$$

where Sₘᵢₙ is the maximum user speed deviation from the mean speed within the window of W, and a is a design parameter for averaging. With a final speed estimate Ŝₚ₋₁ at time tₚ₋₁, the differential range at time tₚ can be estimated as: \hat{D}ₚ=Ŝₚ(tₚ−tₚ₋₁).

### RSTA Determining the Ranging Pattern

In some embodiments, the ISTA may indicate its maximum speed that needs to be tracked. This speed can be reported in the ISTA Speed field of the CP Specific sub-element of the FTM Parameters element or the Ranging Parameters element that it transmits in the FTMR frame to the RSTA. Correspondingly, the RSTA may determine an appropriate pattern for the CPM measurements and may include the determined pattern in the FTM frame it sends in response to the FTMR frame from the ISTA. This pattern can be similar to the Level 1 and Level 2 patterns discussed in one or more embodiment herein, and the pattern can be included in the CP Specific sub-element of the FTM Parameters element or the Ranging Parameters element that the RSTA transmits in FTM frame to the ISTA.

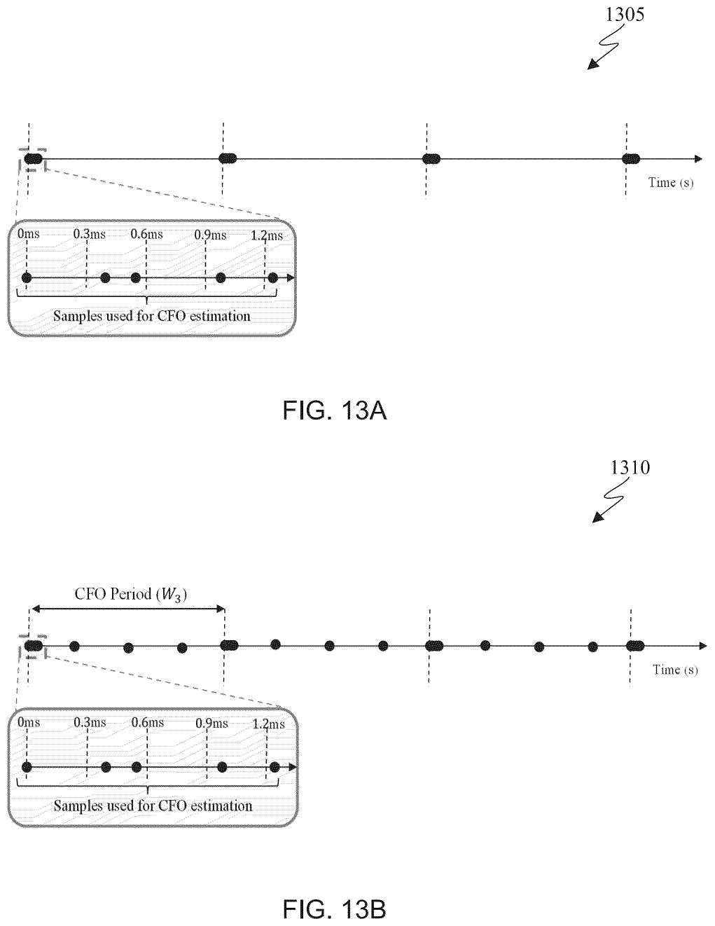

FIG. 13A illustrates an example CFO repetition in each frame CP-ranging exchange sequence 1305 according to various embodiments of the present disclosure. The embodiment of the example CFO repetition in each frame CP-ranging exchange sequence 1305 shown in FIG. 13A is for illustration only. Other embodiments of the example CFO repetition in each frame CP-ranging exchange sequence 1305 could be used without departing from the scope of this disclosure.

FIG. 13B illustrates an example CFO repetition only at the beginning of each CFO period 1310 according to various embodiments of the present disclosure. The embodiment of the example CFO repetition only at the beginning of each CFO period 1310 shown in FIG. 13B is for illustration only. Other embodiments of the example CFO repetition in each frame CP-ranging exchange sequence 1310 could be used without departing from the scope of this disclosure.

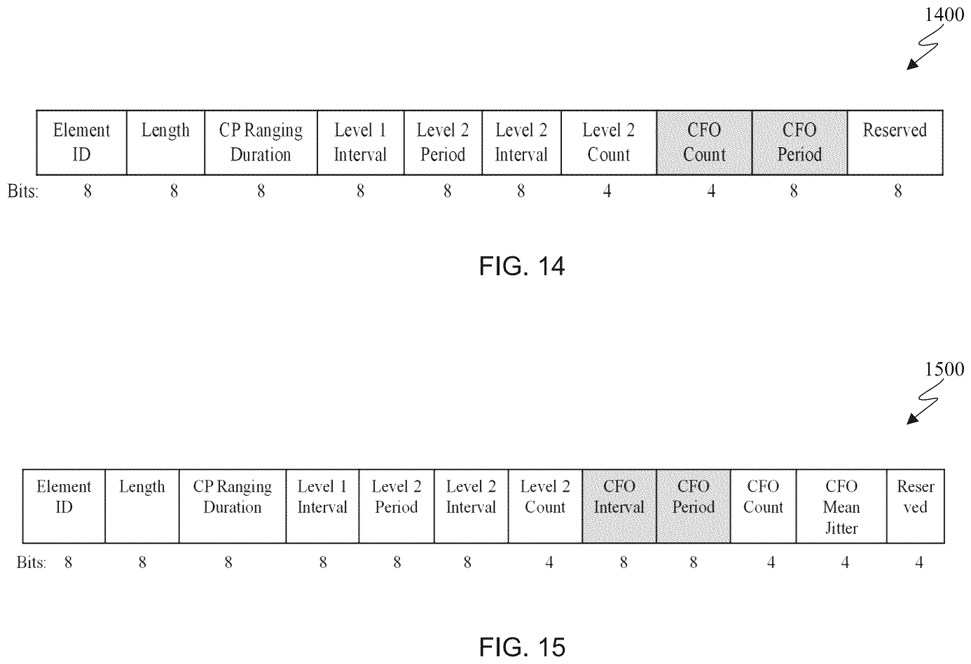

FIG. 14 illustrates yet another example of a CP-specific sub-element of the FTM parameters element or ranging parameters element 1400 according to various embodiments of the present disclosure. The embodiment of the example of a CP-specific sub-element of the FTM parameters element or ranging parameters element 1400 shown in FIG. 14 is for illustration only. Other embodiments of the example of a CP-specific sub-element of the FTM parameters element or ranging parameters element 1400 could be used without departing from the scope of this disclosure.

### Enabling Fine CFO Estimation

In some embodiments, the ISTA and the RSTA may perform the CFO estimation, which is required by the carrier phase-based ranging, by using the short and long training fields and the pilot subcarriers in the frames that they receive.

In some embodiments, the estimate obtained by the above method f̅_{CFO,p} may not have the precision needed for the carrier phase-based ranging. Correspondingly the ISTA may negotiate with an RSTA to indicate a number N₃ of frame exchanges to be performed within each FTM frame exchange sequence to enable fine CFO estimation. All these frame exchanges may be performed in the same transmit opportunity (separated by a short inter frame spacing) as illustrated in FIG. 13A. During the carrier phase reporting, the carrier phase measurement from each of these received frames may be reported. In one example the value of N₃ may be carried in the CFO Count field of the CP Specific sub-element of the FTM Parameters element or the Ranging Parameters element.

In some embodiments, the RSTA may randomly jitter the transmission of each of these N₃ CP measurement frames to enable successful estimation of the CFO. This may be performed by using appropriate padding in the CP measurement frames to create the jitter. An example of this structure for the intra-TXOP frame exchange spacing of 0.3 ms and N₃=5 is depicted in FIG. 13B. In a variant of this embodiment, the use of multiple frame exchanges within the same TXOP may be performed only at the beginning of each time window of length W₃. The value of W₃ may be indicated in the CFO Period field of the CP Specific sub-element of the FTM Parameters element or the Ranging Parameters element. This structure of the sub-element is depicted in FIG. 14.

FIG. 15 illustrates still another example of a CP-specific sub-element of the FTM parameters element or ranging parameters element 1500 according to various embodiments of the present disclosure. The embodiment of the example of a CP-specific sub-element of the FTM parameters element or ranging parameters element 1500 shown in FIG. 15 is for illustration only. Other embodiments of the example of a CP-specific sub-element of the FTM parameters element or ranging parameters element 1500 could be used without departing from the scope of this disclosure.

In some embodiments, the ISTA may negotiate with an RSTA to indicate a number N₃ of frame exchanges to be performed with a very short inter-frame time of T₃ at the beginning of each time window of length W₃, to enable fine CFO estimation. These indications may be carried by the ISTA in the FTMR frame that it transmits to the RSTA to negotiate the CP measurement. The value of N₃ may be indicated in the CFO Count field of the CP Specific sub-element of the FTM Parameters element or the Ranging Parameters element of the FTMR frame. The value of W₃ may be indicated in the CFO Period field of the CP Specific sub-element of the FTM Parameters element or the Ranging Parameters element of the FTMR frame. The value of T₃ may be indicated in the CFO Interval field of the CP Specific sub-element of the FTM Parameters element or the Ranging Parameters element of the FTMR frame. For example, the parameters can be N₃=4, T₃=300 μs and W₃=0.5 s. In another embodiment, the ISTA may also indicate a jitter parameter that indicates the average time value by which each CP Ranging measurement time can be jittered among the N₃ samples to enable robust estimation of the CFO. The RSTA may correspondingly randomly jitter the transmission of each CP measurement frame within the N₃ frame exchanges based on the jitter parameter. This parameter can be included in the CFO Mean Jitter subfield of the Carrier Phase Specific sub-element, as depicted in FIG. 15.

In one example, using the N₃ carrier phase measurements collected with the CFO Period spacing, the refined CFO estimate may be computed for each window of W₃ secs as illustrated in the algorithm below:

Algorithm:

```
Inputs: \hat{ψ}_{p,1}, \hat{ψ}_{p,2}, t_{p,1}, t_{p,4}, f̅_{CFO,p} for p = 1, ... , P.
Wₘₐₓ = ┌(t_{P,1} − t_{1,1})/W₃┐. [symbol]
= { }.
For w = 1: 1: Wₘₐₓ
  Tₛₜ = t_{1,1} + (w − 1)W₃.
  T_{end} = t_{1,1} + wW₃. [symbol]
  = {1 ≤ p ≤ P | Tₛₜ ≤ t_{p,1} ≤ T_{end}, |t_{p,1} − t_{p-1,1}| < 1.5T₃}.
  Compute: fₒₚₜ =
argmax Re{ [symbol]   e^{j(\hat{ψ}}^{_{p,1}}^{-\hat{ψ}}^{_{p,2}}^{-\hat{ψ}}^{_{p−1,1}}^{+\hat{ψ}}^{_{p−1,2}}⁾ e^{j2π(f+f̅}^{_{CFO,p}}^{)[t}^{_{p,4}}^{-t}^{_{p−1,4}}^{+t}^{_{p,1}}^{-t}^{_{p−1,1}}^{]}}
^{|f|≤F}
\hat{ }\hat{f}_{CFO,p} = f̅_{CFO,p} + fₒₚₜ for all p ∈ [symbol]   . [symbol]
  = [symbol]   ∪ [symbol]   .
EndFor
For p ∈ {1, ... , P} \ [symbol]
  Set \hat{f}_{CFO,p} by performing linear interpolation of \hat{f}_{CFO,p} values from q ∈ [symbol]
EndFor
Outputs: \hat{f}_{CFO,p}
```

This value can then be used for estimating the sum-carrier phase Ψ̅ₚ and then be used to estimate the differential range \hat{D}ₚ as explained in one or more embodiments described herein.

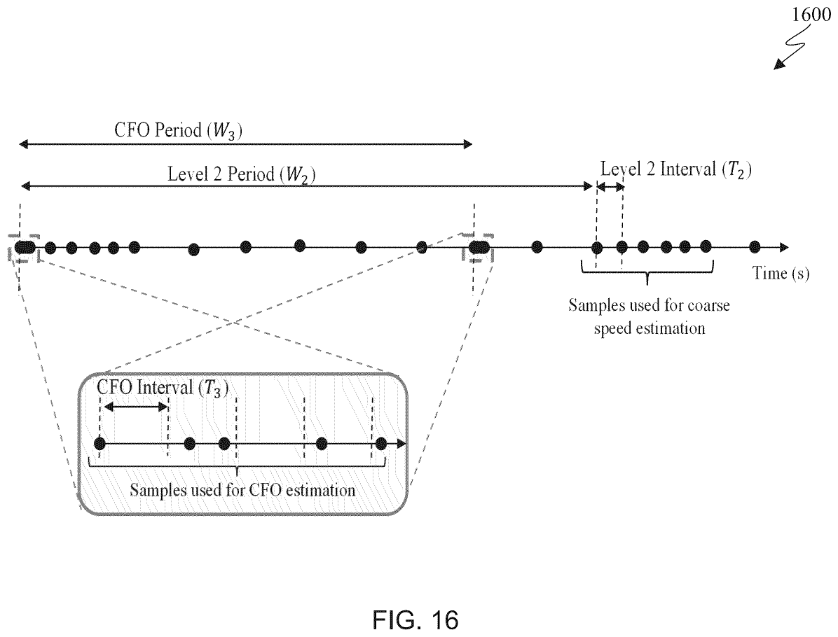

FIG. 16 illustrates an example of a CP Measurement exchange with both level 2 frame exchange and CFO frame exchange negotiated 1600 according to various embodiments of the present disclosure. The embodiment of the example of a CP Measurement exchange with both level 2 frame exchange and CFO frame exchange negotiated 1600 shown in FIG. 16 is for illustration only. Other embodiments of the example of a CP Measurement exchange with both level 2 frame exchange and CFO frame exchange negotiated 1600 could be used without departing from the scope of this disclosure.

In some embodiments, three levels of inter-carrier phase measurement spacings can be used. An illustration for using three levels of inter-carrier phase measurement spacings is illustrated in FIG. 16.

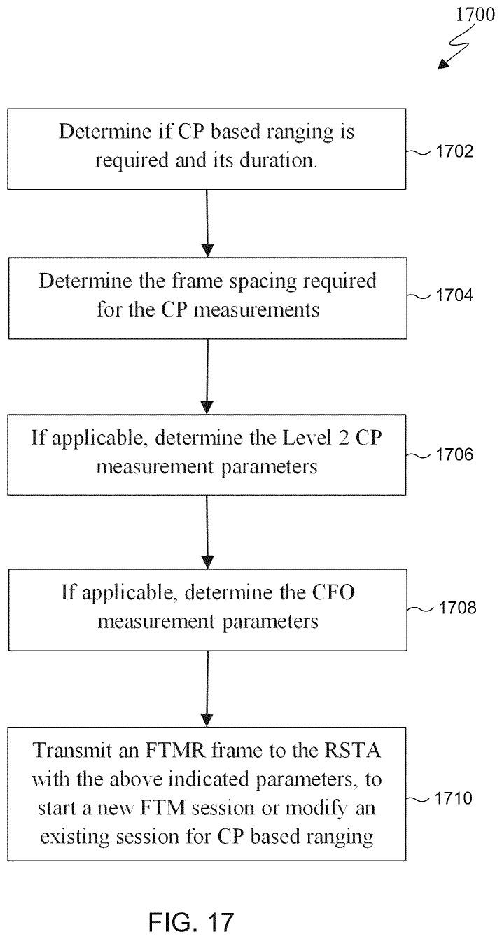

FIG. 17 illustrates an example flow diagram of a method 1700 for wireless communication performed by an ISTA to negotiate the required parameters for CP-based ranging according to embodiments of the present disclosure. The embodiment of the example method 1700 shown in FIG. 17 is for illustration only. Other embodiments of the example method 1700 could be used without departing from the scope of this disclosure.

As illustrated in FIG. 17, the method 1700 begins at step 1702, where the ISTA determines if CP based ranging is required and its duration. At step 1704, the ISTA determines the frame spacing required for the CP measurements. At step 1706, the ISTA determines the Level 2 CP measurement parameters. At step 1708, the ISTA determines the CFO measurement parameters. At step 1710, the ISTA transmits an FTMR frame to the RSTA with the above indicated parameters, to start a new FTM session or modify an existing session for CP based ranging.

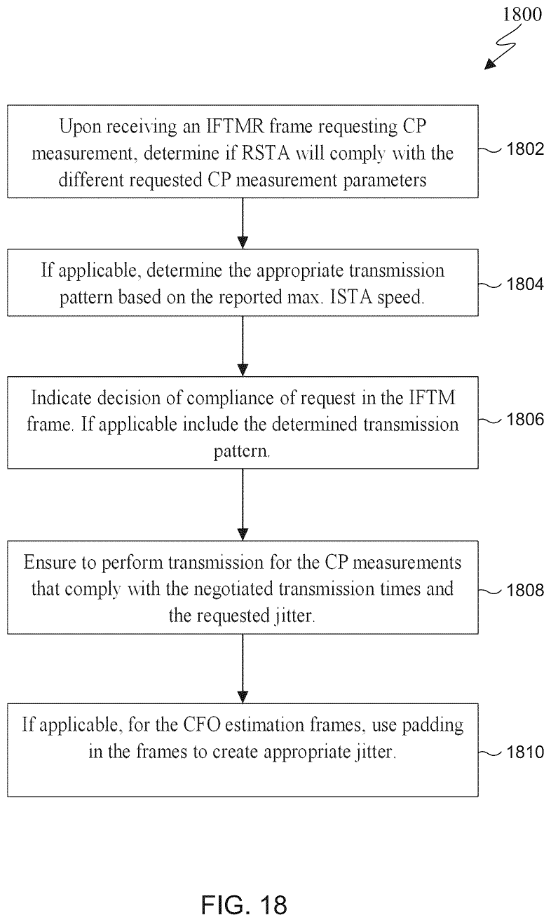

FIG. 18 illustrates an example flow diagram of a method 1800 for wireless communication performed by an RSTA to negotiate the required parameters for CP-based ranging according to embodiments of the present disclosure. The embodiment of the example method 1800 shown in FIG. 18 is for illustration only. Other embodiments of the example method 1800 could be used without departing from the scope of this disclosure.

As illustrated in FIG. 18, the method 1800 begins at step 1802, where the RSTA, upon receiving an IFTMR frame requesting CP measurement, determines if it will comply with the different requested CP measurement parameters. At step 1804, the RSTA determines the appropriate transmission pattern based on the reported maximum ISTA speed. At step 1806, the RSTA indicates a decision of compliance of request in the IFTM frame, and if applicable, includes the determined transmission pattern. At step 1808, the RSTA performs transmission for the CP measurements that comply with the negotiated transmission times and the requested jitter. At step 1810, the RSTA, for the CFO estimation frames, uses padding in the frames to create appropriate jitter.

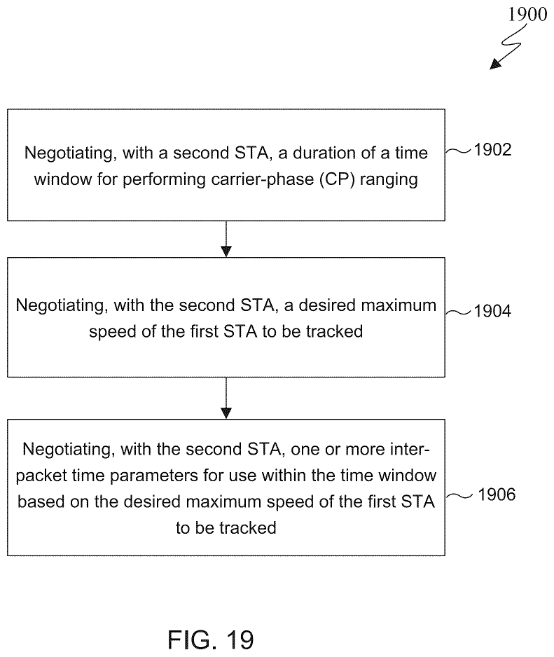

FIG. 19 illustrates an example flow diagram of a method 1900 for wireless communication performed by a first STA to negotiate the required parameters for CP-based ranging according to embodiments of the present disclosure. The embodiment of the example method 1900 shown in FIG. 19 is for illustration only. Other embodiments of the example method 1900 could be used without departing from the scope of this disclosure.

As illustrated in FIG. 19, the method 1900 begins at step 1902, where the first STA negotiates, with a second STA, a duration of a time window for performing carrier-phase (CP) ranging. At step 1904, the first STA negotiates, with the second STA, a desired maximum speed of the first STA to be tracked. At step 1906, the first STA negotiates, with the second STA, one or more inter-packet time parameters for use within the time window based on the desired maximum speed of the first STA to be tracked.

In one embodiment, the one or more inter-packet time parameters includes an average value for the inter-packet times of CP ranging measurement times, and a jitter parameter that indicates an average time value by which each CP ranging measurement time can be jittered for estimation of a differential range between the first STA and the second STA.

In one embodiment, the first STA negotiates, with the second STA, a multi-level pattern for inter-packet times of carrier phase measurements to maximize a detectable first STA speed, while balancing frame exchange overhead, where the multi-level pattern includes a smaller inter-packet time type to track coarse speed up to a maximum detectable first speed and a larger time type to refine fine speed and balance overhead.

In one embodiment, the first STA negotiates, with the second STA, a periodic exchange of multiple Physical Protocol Data Units (PPDUs) in a transmit opportunity (TXOP) to enable accurate carrier frequency offset (CFO) estimation, including at least one of: 1) a number of PPDUs exchanged within the TXOP, 2) one or more inter-PPDU time parameters, or 3) an interval between successive CFO estimations.

In one embodiment, the one or more inter-packet time parameters includes an average value for the inter-packet times for CFO estimation, and a jitter parameter that indicates an average time value by which each CP ranging measurement time can be jittered for CFO estimation.

In one embodiment, the time window is a subset of a Fine Timing Measurement (FTM) ranging session.

In one embodiment, the first STA receives, from a third STA and prior to negotiating: (i) the duration of the time window, (ii) the desired maximum speed, and (iii) the one or more inter-packet time parameters, an indication including parameters for performing CP ranging with the third STA.

In one embodiment, the first STA is an ISTA and the second STA is an RSTA.

The above flowcharts illustrate example methods that can be implemented in accordance with the principles of the present disclosure and various changes could be made to the methods illustrated in the flowchart. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method of wireless communication performed by a first station (STA), the method comprising:
negotiating, with a second STA, a duration of a time window for performing carrier-phase (CP) ranging;
negotiating, with the second STA, a desired maximum speed of the first STA to be tracked; and
negotiating, with the second STA, one or more inter-packet time parameters for use within the time window based on the desired maximum speed of the first STA to be tracked.

2. The method of claim 1, wherein the one or more inter-packet time parameters includes an average value for the inter-packet times of CP ranging measurement times, and a jitter parameter that indicates an average time value by which each CP ranging measurement time can be jittered for estimation of a differential range between the first STA and the second STA.

3. The method of claim 1, further comprising:
negotiating, with the second STA, a multi-level pattern for inter-packet times of carrier phase measurements to maximize a detectable first STA speed, while balancing frame exchange overhead,
wherein the multi-level pattern includes a smaller inter-packet time type to track coarse speed up to a maximum detectable first speed and a larger time type to refine fine speed and balance overhead.

4. The method of claim 1, further comprising:
negotiating, with the second STA, a periodic exchange of multiple Physical Protocol Data Units (PPDUs) in a transmit opportunity (TXOP) to enable accurate carrier frequency offset (CFO) estimation, including at least one of: 1) a number of PPDUs exchanged within the TXOP, 2) one or more inter-PPDU time parameters, or 3) an interval between successive CFO estimations.

5. The method of claim 4, wherein the one or more inter-packet time parameters includes an average value for the inter-packet times for CFO estimation, and a jitter parameter that indicates an average time value by which each CP ranging measurement time can be jittered for CFO estimation.

6. The method of claim 1, wherein the time window is a subset of a Fine Timing Measurement (FTM) ranging session.

7. The method of claim 1, further comprising:
receiving, from a third STA and prior to negotiating: (i) the duration of the time window, (ii) the desired maximum speed, and (iii) the one or more inter-packet time parameters, an indication including parameters for performing CP ranging with the third STA.

8. The method of claim 1, wherein the first STA is an initiating station (ISTA) and the second STA is a responding station (RSTA).

9. A first station (STA) comprising:
a transceiver; and
a processor operably coupled to the transceiver, the processor configured to:
negotiate, with a second STA, a duration of a time window for performing carrier-phase (CP) ranging;
negotiate, with the second STA, a desired maximum speed of the first STA to be tracked; and
negotiate, with the second STA, one or more inter-packet time parameters for use within the time window based on the desired maximum speed of the first STA to be tracked.

10. The first STA of claim 9, wherein the one or more inter-packet time parameters includes an average value for the inter-packet times of CP ranging measurement times, and a jitter parameter that indicates an average time value by which each CP ranging measurement time can be jittered for estimation of a differential range between the first STA and the second STA.

11. The first STA of claim 9, wherein the processor is further configured to:
negotiate, with the second STA, a multi-level pattern for inter-packet times of carrier phase measurements to maximize a detectable first STA speed, while balancing frame exchange overhead,
wherein the multi-level pattern includes a smaller inter-packet time type to track coarse speed up to a maximum detectable first speed and a larger time type to refine fine speed and balance overhead.

12. The first STA of claim 9, wherein the processor is further configured to:
negotiate, with the second STA, a periodic exchange of multiple Physical Protocol Data Units (PPDUs) in a transmit opportunity (TXOP) to enable accurate carrier frequency offset (CFO) estimation, including at least one of: 1) a number of PPDUs exchanged within the TXOP, 2) one or more inter-PPDU time parameters, or 3) an interval between successive CFO estimations.

13. The first STA of claim 12, wherein the one or more inter-packet time parameters includes an average value for the inter-packet times for CFO estimation, and a jitter parameter that indicates an average time value by which each CP ranging measurement time can be jittered for CFO estimation.

14. The first STA of claim 1, wherein the time window is a subset of a Fine Timing Measurement (FTM) ranging session.

15. The first STA of claim 9, wherein the processor is further configured to:
receive, from a third STA and prior to negotiating: (i) the duration of the time window, (ii) the desired maximum speed, and (iii) the one or more inter-packet time parameters, an indication including parameters for performing CP ranging with the third STA.

16. The first STA of claim 9, wherein the first STA is an initiating station (ISTA) and the second STA is a responding station (RSTA).

17. A responding station (RSTA) comprising:
a transceiver; and
a processor operably coupled to the transceiver, the processor configured to:
receive a message from an initiating station (ISTA) requesting carrier-phase (CP) measurement;
transmit, to the ISTA, an indication for support of the CP measurement;
negotiate, with the ISTA, a duration of a time window for performing carrier-phase (CP) ranging;
negotiate, with the ISTA, a desired maximum speed of the ISTA to be tracked; and
negotiate, with the ISTA, one or more inter-packet time parameters for use within the time window based on the desired maximum speed of the ISTA to be tracked.

18. The RSTA of claim 17, wherein the one or more inter-packet time parameters includes an average value for the inter-packet times of CP ranging measurement times, and a jitter parameter that indicates an average time value by which each CP ranging measurement time can be jittered for estimation of a differential range between the ISTA and the RSTA.

19. The RSTA of claim 17, wherein the processor is further configured to:
negotiate, with the ISTA, a multi-level pattern for inter-packet times of carrier phase measurements to maximize a detectable ISTA speed, while balancing frame exchange overhead,
wherein the multi-level pattern includes a smaller inter-packet time type to track coarse speed up to a maximum detectable first speed and a larger time type to refine fine speed and balance overhead.

20. The RSTA of claim 17, wherein the processor is further configured to:
negotiate, with the ISTA, a periodic exchange of multiple Physical Protocol Data Units (PPDUs) in a transmit opportunity (TXOP) to enable accurate carrier frequency offset (CFO) estimation, including at least one of: 1) a number of PPDUs exchanged within the TXOP, 2) one or more inter-PPDU time parameters, or 3) an interval between successive CFO estimations.
